(19) United States
(12) Patent Application Publication
(10) Pub. No.: US 2007/0035612 A1
(43) Pub. Date: Feb. 15, 2007

(54) Method and apparatus to capture and compile information perceivable by multiple handsets regarding a single event

(76) Inventors: Jose E. Korneluk, Boynton Beach, FL (US); Von A. Mock, Boynton Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/199,755

(22) Filed: Aug. 9, 2005

(51) Int. Cl. H04N 7/14

(52) U.S. Cl. 348/14.01

(57) ABSTRACT

A method and system (100) for capturing event information relating to an event (114) perceivable by a remote input device (102, 104, 106, and 108) capturing event information, including audio and video information, by the remote input device (102, 104, 106, and 108); synchronizes the captured information to a time source; encodes the synchronized information to a format suitable for transmission; and transmits the encoded information from the remote input device (102, 104, 106, and 108) for reception by a central processing system (130). The captured event information is encoded with event-specific information, geographic location information, or ancillary information. The event (114) perceivable by a remote input device (102, 104, 106, and 108) occurs externally to that input device and may occur over a substantial geographic area. The remote input device includes a wireless device. The synchronized information is encoded to a format suitable for wireless transmission. The encoded information is transmitted wirelessly from the wireless device and is destined for reception by a central processing system (130).

### CROSS-REFERENCE TO RELATED APPLICATIONS

The present patent application is related to co-pending and commonly owned U.S. patent application Ser. No. ______, Attorney Docket No. CE14754JSW, entitled “Method and Apparatus to Reconstruct and Play Back Information Perceivable by Multiple Handsets Regarding a Single Event,” filed on the same date with the present patent application, the entire teachings of which is hereby incorporated by reference.

### FIELD OF THE INVENTION

The present invention generally relates to the field of telecommunications and more specifically to a method and apparatus to capture and compile information perceived by multiple cellular handsets when reporting a wide-area event, and to utilize the information to determine attributes of the event.

### BACKGROUND OF THE INVENTION

The proliferation of cellular phones has enabled a vast majority of people to communicate in just about any time of day and location. Thus, in the event of an emergency, there are generally several persons in the vicinity with the ability to notify law enforcement officials or emergency medical personnel almost instantly. The amount of people reporting the same emergency is steadily increasing as a result of the ubiquitous nature of the cell phone. However, law enforcement and other emergency agencies receive limited information from the caller(s) in light of the technological capabilities of the cellular telephone. Generally, information received from the caller(s) is only in the form of audible expression from that particular caller recounting the events witnessed. The information gathered is thus limited to the caller's verbal ability to describe the emergency event he is witnessing (i.e. fire, explosion, collision, gunshots, beating).

The emotional nature of the event itself may further hamper this ability. Often, when someone is reporting an emergency, the person calling is so concerned about the actual event that it is difficult to give an emergency operator accurate enough information to obtain assistance in the quickest possible time.

Further, in the event of a particularly extensive emergency, there are several callers attempting to simultaneously report the same emergency event. In that scenario, there is a real possibility that several emergency operators are receiving duplicate or even conflicting information without even realizing other operators are addressing the same situation. This results in collecting a massive amount of information with no clear or convenient method for understanding the full impact of the current situation:

The latest cell phones on the market include built-in cameras, voice recorders, location assist, as well as capabilities to send and receive multimedia. Additionally, some models include accelerometers that give the user the ability to navigate by tilting and twisting the device. Previously, emergency personnel have been able to take pictures of an emergency scene (victim) and transmit this image to a hospital's emergency room so that doctors can prepare for the type of operation to be performed. However, the common person is not yet able to provide this type of function to a “911” operator even though the phone he carries everyday has this ability already built-in. Architecture advancements in the Open Mobile Alliance's (OMA) IP Multimedia SubSystem (IMS) will allow an individual to snap a picture and provide this information to the emergency dispatch center. However, there still exists the problem of discerning the many images provided during the time of the emergency into a common stream of information in order to provide the most advantageous use of the information to personnel responding to the emergency.

Additionally, certain other events that occur over a fairly extensive geographical area, such as football games, the Olympics, or concerts, tend to have people witnessing or perceiving the events from a variety of perspectives. However, someone viewing the event only has the capability to record or playback the event from his own point of observation, even though there are other viewers watching the event concurrently and from a variety of perspectives.

Therefore, a need exists to overcome the problems with the prior art, as discussed above.

### SUMMARY OF THE INVENTION

Briefly, one embodiment of the present invention provides a method, wireless input device, and system for capturing event information relating to an event perceivable by a remote input device by capturing event information, including audio and video information, by at least one remote input device; synchronizing the captured information to a time source; encoding the synchronized information to a format suitable for transmission; and transmitting the encoded information from the remote input device for reception by a central processing system. The captured event information is encoded with event-specific information, geographic location information, or ancillary information. Further, the method stores the encoded information at a memory location in the remote input device.

The remote input device is a wireless device, and the synchronized information is encoded to a format suitable for wireless transmission. Further, the encoded information is transmitted wirelessly from the wireless device, and is destined for reception by a central processing system.

The event perceivable to the input device occurs external to the input device and over a substantial geographic area.

The system also contains a central processing system for receiving event information from the remote input device, decoding the received event information; storing the decoded event information in memory; compiling the stored, decoded event information according to a predefined arrangement; and analyzing the compiled event information. In one embodiment, the system has a plurality of remote input devices for capturing event information relating to an event perceivable by each remote input device and each remote input device captures the event information from an independent vantage point. The event information captured from each remote input device is stored as an independent record.

The system compiles the stored information by determining geographic location information for each independent stored record; determining a relative location from the geographic location of each record received from a remote input device for a particular event to the geographic location of at least one other record received from a different remote input device of the plurality of remote input devices capturing event information of the same event from a different vantage point; and creating a composite information file of the event using the geographic location of at least two independent stored records and the corresponding synchronized information.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a wide-area event information processing system in accordance with one embodiment of the present invention;

FIG. 2 is a detailed block diagram depicting a wireless device of the wide-area event information processing system of FIG. 1 according to one embodiment of the present invention;

FIG. 3 is a detailed block diagram depicting a wide-area event information processing server of the system of FIG. 1, according to one embodiment of the present invention;

FIG. 4 is a detailed block diagram of a wide-area event information processing client application residing in the wireless device of FIG. 2, according to one embodiment of the present invention;

FIG. 5 is a detailed block diagram of a wide-area event information processing server application embedded in the server of FIG. 3, according to one embodiment of the present invention;

FIG. 6 is a detailed block diagram of a series of records of the event captured by one or more wireless devices of the event recording system of FIG. 1, according to an embodiment of the present invention;

FIG. 7 is an operational flow diagram illustrating an operational sequence for a handset to capture and upload streaming audio, according to an embodiment of the present invention;

FIG. 8 is an operational flow diagram illustrating an operational sequences for a server to synchronize multiple captured audio files received from one or more wireless devices of the system of FIG. 1, and create a composite audio file, according to an embodiment of the present invention;

FIG. 9 is a diagram illustrating exemplary captured audio samples from multiple users of the emergency recording system of FIG. 1 and a composite of the audio samples, according to an embodiment of the present invention;

FIG. 10 is an operational flow diagram illustrating an operational sequences for a handset to capture and upload still frame images, according to an embodiment of the present invention;

FIG. 11 is an operational flow diagram illustrating an operational sequences for a handset to capture and upload streaming video, according to an embodiment of the present invention;

FIG. 12 is an operational flow diagram illustrating an operational sequence for receiving emergency event video information by a server, according to an embodiment of the present invention;

FIG. 13 is an information flow diagram illustrating an integrated process for uploading information to an emergency data server from multiple wireless devices of the system of FIG. 1, during an emergency event, according to an embodiment of the present invention;

FIG. 14 is an operational flow diagram illustrating an operational sequence for a handset to request playing back portions of data received from one or more wireless devices during an emergency event, according to an embodiment of the present invention;

FIG. 15 is an operational flow diagram illustrating an operational sequence for a server playing back portions of data received from one or more wireless devices during an emergency event, according to an embodiment of the present invention;

FIG. 16 is an operational flow diagram illustrating an operational sequence for a server playing back a panoramic view of data received from one or more wireless devices during an emergency event, according to an embodiment of the present invention; and

FIG. 17 is an information flow diagram illustrating an integrated process for playing back information from an emergency event recording server to at least one handset device.

### DETAILED DESCRIPTION

Terminology Overview

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an,” as used herein, are defined as “one” or “more than one.” The term “plurality,” as used herein, is defined as “two” or “more than two.” The term “another,” as used herein, is defined as “at least a second or more.” The terms “including” and/or “having,” as used herein, are defined as “comprising” (i.e., open language). The term “coupled,” as used herein, is defined as “connected, although not necessarily directly, and not necessarily mechanically.” The terms “program,” “software application,” and the like as used herein, are defined as “a sequence of instructions designed for execution on a computer system.” A program, computer program, or software application typically includes a subroutine, a function, a procedure, an object method, an object implementation, an executable application, an applet, a servlet, a source code, an object code, a shared library/dynamic load library and/or other sequence of instructions designed for execution on a computer system.

While the specification concludes with claims defining the features of the invention that are regarded as novel, it is believed that the invention will be better understood from a consideration of the following description in conjunction with the drawing figures, in which like reference numerals are carried forward.

Overview

The present invention overcomes problems with the prior art by aggregating the many images provided during the time of the emergency into a common stream of information that conveys the user's direction when the image was taken along with the time of instance. This collection of images along with a timeline, textual data and sound from each perspective person is then serialized into a multimedia message that can be transmitted to the emergency team responders. Additionally, each person's microphone from his or her cellular phone can be utilized to gather further information about the emergency situation. Knowing the location of the cell phones and the arrival time of the sound at each microphone can provide information on the direction and approximate source of the sound from a given cell phone. This information can be vital to the early emergency responders to quickly identify the location of the source and resolving the situation.

Wide-Area Event Information Processing System

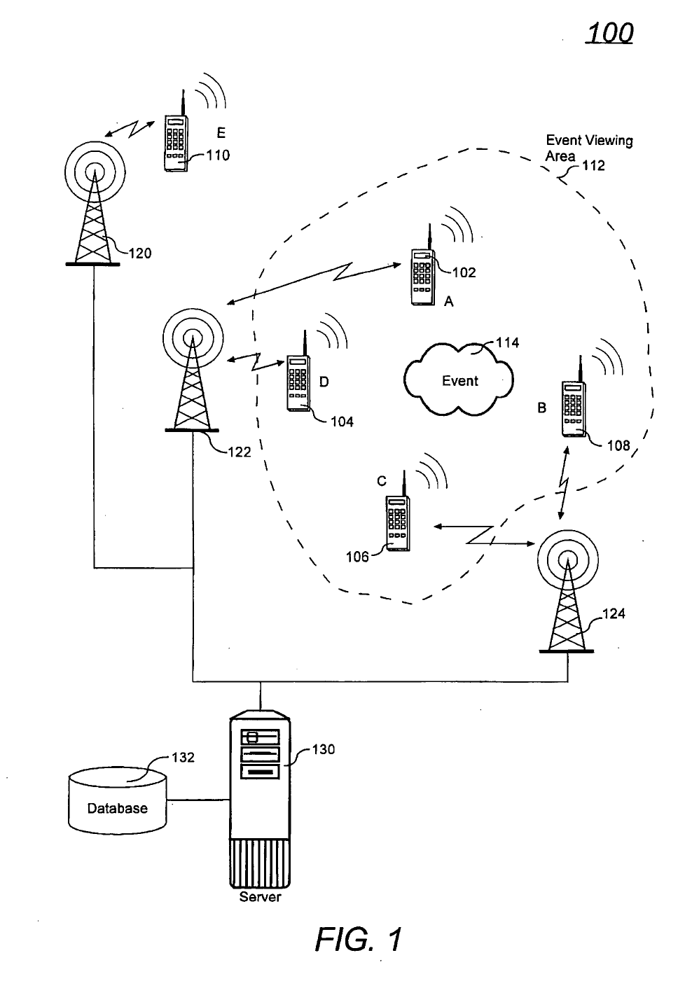

FIG. 1 illustrates a wide-area event information processing system 100 in accordance with one embodiment of the present invention. The exemplary system includes at least two wireless mobile subscriber devices (or wireless devices) 102, 104, 106, and 108 whose users are in the event area 112. Each wireless device 102, 104, 106, and 108 is capturing data in the form of still images, audio, and/or video of the event 114. Each wireless device 102, 104, 106, and 108 is operating within range of a cellular base station 120, 122, and 124. Each cellular base station 120, 122, and 124 has the ability to communicate with other base stations and thus is able to communicate with other wireless devices 102, 104, 106, and 108. This allows a user 110 outside, or external to the event 114 to perceive the actual event 114.

Additionally, user of device 102, 104, 106, and 108 can see a time slice of the event 114 from one or more perspectives of A, B, C, or D (102, 104, 106, or 108) even though they themselves may have only a narrow angle view of the actual event 114. Data collected at the event area 112, is sent to an emergency event recording server 130 for processing and stored in an emergency event database 132. Note that it is within the scope of the invention for a device capturing the wide-area event to be wire-line telephones, personal data assistants, mobile or stationary computers, cameras or any other device capable of capturing and transmitting information.

A particular reported event could occur over a substantial geographic area. For instance, the event could be a sporting event, such as a football game occurring within a stadium, a basketball game in a gymnasium, or a very large event such as the Olympics or a tennis tournament, both of which typically have several games happening simultaneously. Additionally, a crime that occurs in one part of a town may have people reporting information relating to the crime from all over town. For instance, if a bank robbery occurred, typically there could be 911 calls reporting the initial robbery and also subsequent callers reporting actions of the suspects after the robbery—such as a the location the suspects were seen, information regarding a high speed chase involving the suspects, or even accidents involving the suspects. However, the scope of the invention also includes a single contained event such as a speech given to a small gathering located within a single room.

In one instance, common portions of two or more images captured at the event area 112, are overlaid to create a panoramic view of the event area 112. For example, images from device 106, with a point-of-view of C, and images from device 108, with a point-of-view of B, are communicated to cellular base station 124. The images are combined at the emergency event recording server 130 and stored in the event database 132. User of device 110, having a point-of-view of E, outside the event area 112, communicates a request for the panoramic view (or any other single or combined view) through cellular base station 120. The server 130 then sends the requested information to device 110. Additionally, user of device 102, having a point-of-view of A, can request to view a time slice of the event 114 from a combination of data captured from angle A, B, C, or D, even though user 102 may only have a limited, narrow-angle view of the actual event 114.

Wide-Area Event Information Capturing Wireless Device

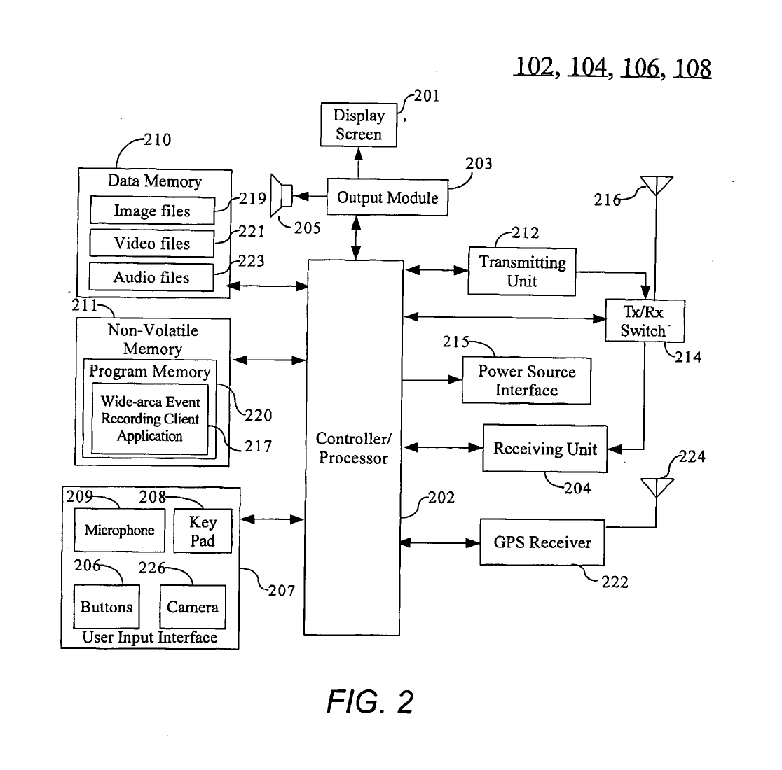

Referring to FIG. 2, a wireless device 102, 104, 106, and 108, in accordance with one embodiment of the present invention is shown in more detail. (The terms “electronic device”, “phone”, “cell phone”, “radio”, and “wireless device” are used interchangeably throughout this document in reference to an exemplary electronic device.) The wireless device 102, 104, 106, and 108 of the exemplary wide-area event information processing system 100 includes a keypad 208, other physical buttons 206, a camera 226 (optional), and an audio transducer such as in a microphone 209 to receive and convert audio signals to electronic audio signals for processing in the electronic device 102 in a well known manner, all of which are part of a user input interface 207. The user input interface 207 is communicatively coupled with a controller/processor 202. The electronic device 102, 104, 106, and 108, according to this embodiment, also comprises a data memory 210; a non-volatile memory 211 containing a program memory 220, an optional image file 219, video file 221 and audio file 223; and a power source interface 215.

The electronic device 102, 104, 106, and 108, according to this embodiment, comprises a wireless communication device, such as a cellular phone, a portable radio, a PDA equipped with a wireless modem, or other such type of wireless device. The wireless communication device 102, 104, 106, and 108 transmits and receives signals for enabling a wireless communication such as for a cellular telephone, in a well known manner. For example, when the wireless communication device 102, 104, 106, and 108 is in a “receive” mode, the controller 202 controls a radio frequency (RF) transmit/receive switch 214 that couples an RF signal from an antenna 216 through the RF transmit/receive (TX/RX) switch 214 to an RF receiver 204, in a well known manner. The RF receiver 204 receives, converts, and demodulates the RF signal, and then provides a baseband signal to an audio output module 203 and a transducer 205, such as a speaker, to output received audio. In this way, for example, received audio can be provided to a user of the wireless device 102. Additionally, received textual and image data is presented to the user on a display screen 201. A receive operational sequence is normally under control of the controller 202 operating in accordance with computer instructions stored in the program memory 220, in a well known manner.

In a “transmit” mode, the controller 202, for example responding to a detection of a user input (such as a user pressing a button or switch on the keypad 208), controls the audio circuits and couples electronic audio signals from the audio transducer 209 of a microphone interface to transmitter circuits 212. The controller 202 also controls the transmitter circuits 212 and the RF transmit/receive switch 214 to turn ON the transmitter function of the electronic device 102. The electronic audio signals are modulated onto an RF signal and coupled to the antenna 216 through the RF TX/RX switch 214 to transmit a modulated RF signal into the wireless communication system 100. This transmit operation enables the user of the device 102 to transmit, for example, audio communication into the wireless communication system 100 in a well known manner. The controller 202 operates the RF transmitter 212, RF receiver 204, the RF TX/RX switch 214, and the associated audio circuits according to computer instructions stored in the program memory 220.

Optionally, a GPS receiver 222 couples signals from a GPS antenna 224 to the controller to provide information to the user regarding the current physical location of the wireless device 102, 104, 106, and 108 in a manner known well in the art.

Wide-Area Event Information Processing Server

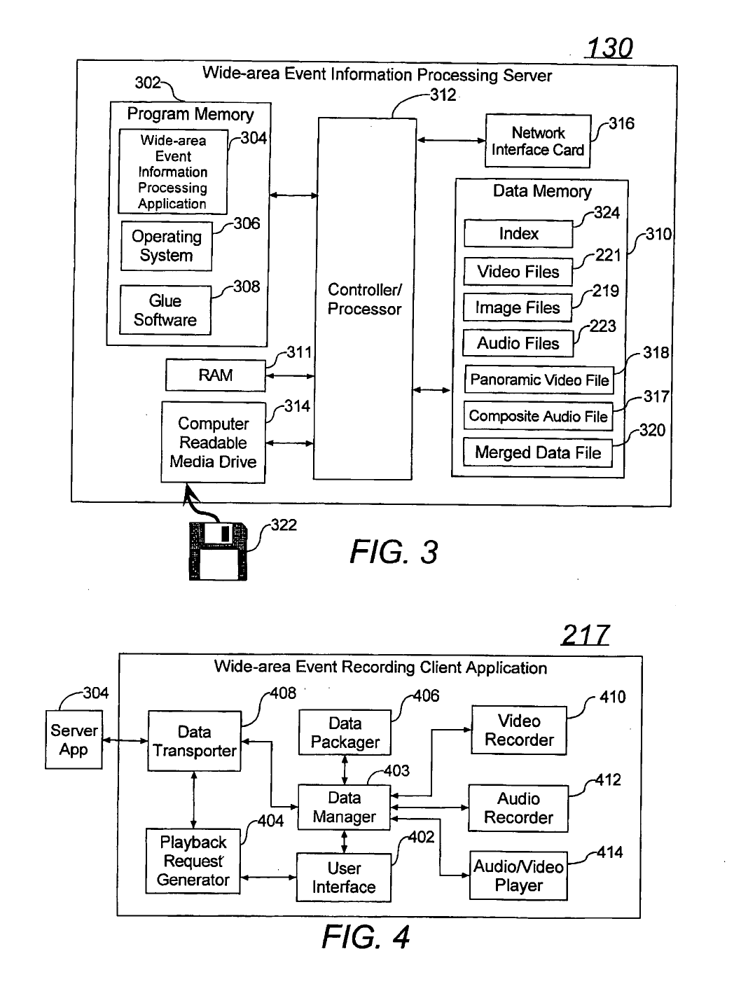

A more detailed block diagram of a wide-area event information processing server 130 according to an embodiment of the present invention is shown in FIG. 3. The server 130 includes one or more processors 312 which process instructions, perform calculations, and manage the flow of information through the server 130. The server 130 also includes a program memory 302, a data memory 310, and random access memory (RAM) 311. Additionally, the processor 312 is communicatively coupled with a computer readable media drive 314, at least one network interface card (NIC) 316, and the program memory 302. The network interface card 316 may be wired or wireless interfaces.

Included within the program memory 302 are a wide-area event information processing application 304, operating system platform 306, and glue software 308. The operating system platform 306 manages resources, such as the information stored in data memory 310 and RAM 311, the scheduling of tasks, and processes the operation of the emergency event recording application 304 in the program memory 302. Additionally, the operating system platform 306 also manages many other basic tasks of the server 130 in a well-known manner.

Glue software 308 may include drivers, stacks, and low-level application programming interfaces (API's); it provides basic functional components for use by the operating system platform 306 and by compatible applications that run on the operating system platform 306 for managing communications with resources and processes in the server 130.

Various software embodiments are described in terms of this exemplary computer system. After reading this description, it will become apparent to a person of ordinary skill in the relevant art(s) how to implement embodiments of the present invention using any other computer systems and/or computer architectures.

In this document, the terms “computer program medium,” “computer-usable medium,” “machine-readable medium” and “computer-readable medium” are used to generally refer to media such as program memory 302 and data memory 310, removable storage drive, a hard disk installed in hard disk drive, and signals. These computer program products are means for providing software to the server 130. The computer-readable medium 322 allows the server 130 to read data, instructions, messages or message packets, and other computer-readable information from the computer-readable medium 322. The computer-readable medium 322, for example, may include non-volatile memory, such as Floppy, ROM, Flash memory, disk drive memory, CD-ROM, and other permanent storage. It is useful, for example, for transporting information, such as data and computer instructions, between computer systems. Furthermore, the computer-readable medium 322 may comprise computer-readable information in a transitory state medium such as a network link and/or a network interface, including a wired network or a wireless network, that allow a computer to read such computer-readable information.

Operation of the Wide-Area Event Information Processing System

The event recording system has two primary modes of operation; capture/compile and reconstruct/playback. During the capture/compile mode, information surrounding an event is captured and uploaded by a wireless handset device 102 to the event information server 130 where it is indexed, processed, and stored in the event database 132. During the reconstruct/playback mode, users request information concerning the event from the event information server 130 using a wireless handset device 102, and the server 130 sends the requested information to the handset device 102 to reconstruct the happenings of the event.

Capture/Compile Mode

The capture/compile mode encompasses the input phase of operation. Data recorded at the scene of the wide-area event is stored at the server 130 in an arrangement based on attributes such as the time received, composition of the data, and data source, in a manner enabling convenient retrieval of information by other users.

Event Recording Client Application in Handset Device

Briefly, in one exemplary embodiment of the present invention, as shown in FIG. 4, the event recording client application, residing in the wireless handset device 102, 104, 106, and 108, captures information concerning the event 114 (such as sound, still images, video, or textual descriptions), transfers this information to the emergency event recording server 130, requests playback of various forms of the information compiled by the server 130, and presents the information to the user in the format requested. The information presented may be that which was collected by the user himself, information from the point of view of another observer, or a compilation of data from multiple users. A user interface 402 allows the user to choose the type of information he wishes to capture. A data manager 403 controls the flow of information within the client application 217 and collects data by communicating with a video recorder 410, an audio recorder 412, as well as the user interface to capture textual descriptions of the event 114 entered directly from the user. The captured information is then encoded with other relevant information, such as event specific information like time or geographic location, as well as other ancillary information not specific to that particular event such as environmental factors like temperature, seat number, etc., by the data packager 406 and transferred to the event recording server 130 via a data transporter 408. Additionally, the user may request playback of information obtained at the scene of the event 114 through the user interface 402, which initiates the playback request generator 404 to create a request for relevant information. The user may request all relevant information pertaining to the event 114 or limit the request to certain forms of information, (e.g. only audible or visual data), information from a specific user point of view, or a combination of data from multiple independent vantage points. The request is then transmitted to the server 130 via the data transporter 408. Requested information is also received from the server 130 by the data transporter 408. The data manager 403 then instructs an audio/video player 414 to playback the requested information to the user.

Wide-Area Event Information Server Application

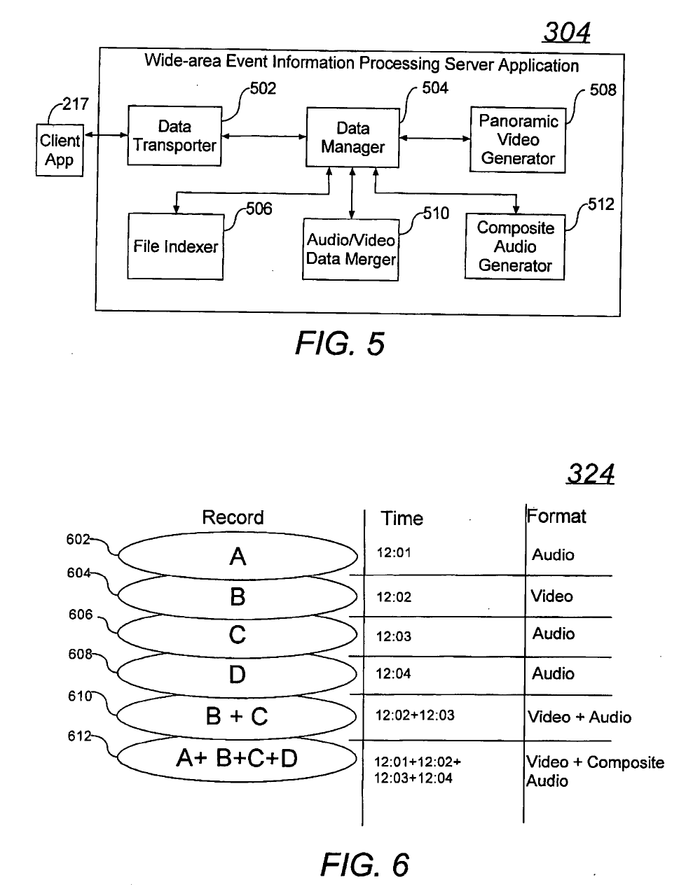

Referring to FIG. 5, as in the case of the client application 217, information is transferred between the wide-area event information server application 304 and wireless handset devices 102, 104, 106, and 108 by way of a data transporter 502, and the flow of information within the server application 304 is controlled by a data manager 504. A panoramic video generator 508 combines video images, synchronized in time, from two or more vantage points (sources) to create a panoramic image 318 of the emergency event scene 112. Similarly, a composite audio generator 512 combines audio files, synchronized in time, to create a composite audio file 317 of the emergency event. An audio/video data merger 510 combines an audio file with a video file to create a more complete report of the emergency event 112. A file indexer 506 creates an index 324 of all files received and/or created for each emergency event 130.

The index 324, as shown in FIG. 6, references each file according to source, time, and format of data. Each file, or record, may contain independent information from a single source, or from multiple sources. For example, record 602 contains audio information recorded from source (or user) A, beginning at 12:01. Record 604 contains video information captured by source B, beginning at 12:02. Record 606 contains audio data recorded by source C, beginning at 12:03. Record 608 contains audio data recorded from source D, beginning at 12:04. Record 610 is a merged data file 320 containing both the video captured by user B and the audio captured by user C, synchronized according to the time frame of each file. Likewise, record 612 contains the video captured by user B, as well as composite audio data compiled from the audio recorded by users A, C, and D, with the audio and video files having been synchronized according to time.

Capture/Compile Audio

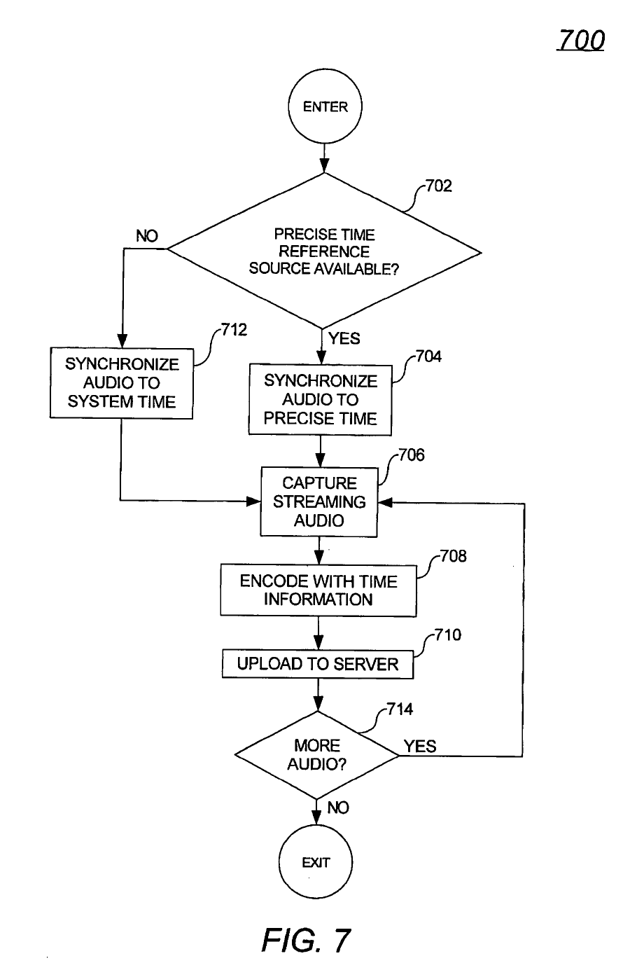

An exemplary operational sequence for a handset 102 to capture and upload streaming audio, according to an embodiment of the present invention is illustrated in FIG. 7. Beginning at step 702, the client application 217 checks the availability of a precise time reference source. If a precise time reference source is available, the data manager 403 of the client application 217 synchronizes the audio to the precise time, at step 704. For example, the iDEN network is synchronized with GMT (UTC) time (System time) and is a very accurate time source. Other systems may not have this luxury and therefore the device may rely on the GPS timing which is also very accurate. If a precise time source is not available, the client application will synchronize the audio to the system time, at step 712. The audio recorder 412 begins capturing streaming audio at step 706. The streaming audio is encoded with the time information, to a format suitable for transmission at step 708, and uploaded, or transmitted, with the final destination as being received by the event recording server 130 of a central processing system, at step 710. The client application 217 the checks, at step 714 to see if any further audio is to be transferred. If so, the process returns to step 706 to capture additional streaming audio, otherwise, the process ends.

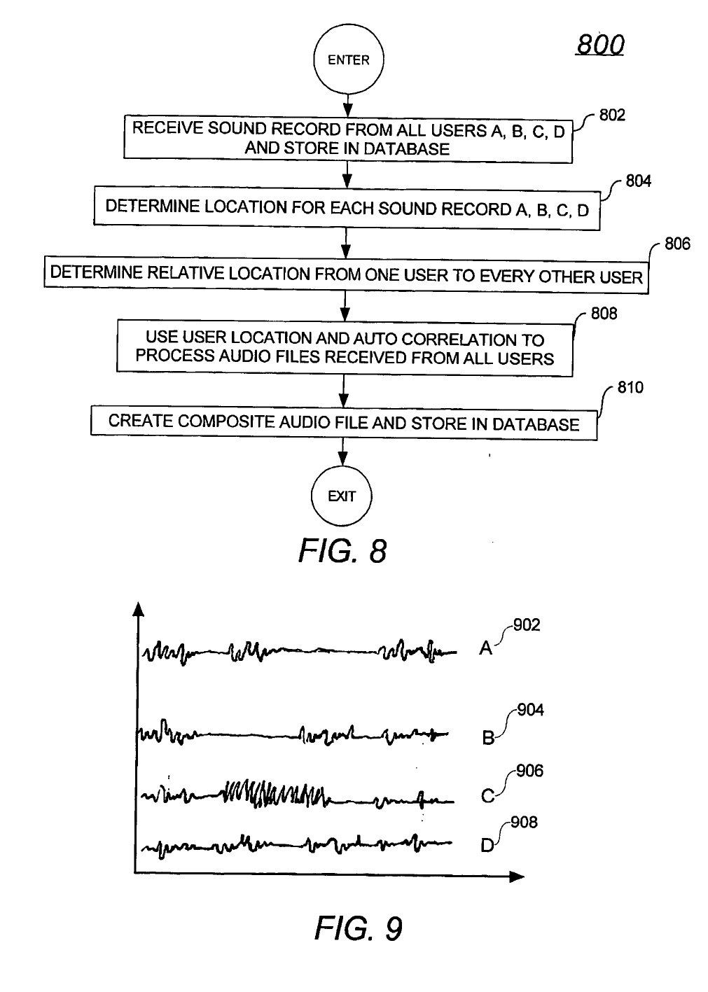

FIG. 8 illustrates an exemplary operational sequence for compiling received audio, from the point of view of the wide-area event information processing server 130. The process begins at step 802 when the server 130 receives sound records from several users and stores each audio record in the event database 132. Next, the method determines the location of each user from location data provided by GPS information within each sound record, at step 804. The method then determines the relative location from one user to every other user, at step 806. The method the uses the user location and well-known auto-correlation techniques to process the audio files received from all users, at step 808. Finally, at step 810, a composite audio file is created from two or more individual audio files and stored in the event database 132. The time stamp information encoded within each sound file at the originating handset devise is also used in the creation of the composite audio recording to align the individual audio tracks in time. For example, in FIG. 9, three individual audio tracks have been collected from users A 902, B 904, and C 906. However, file A 902 and file B 904 contain missing information, and file C 906 contains an undesired artifact such as excess noise within the signal. Using auto-correlation techniques, the three files A 902, B 904, and C 906 are combined to form one composite audio file D 908 which now contains a clear audio recording of the event.

Capture/Compile Video

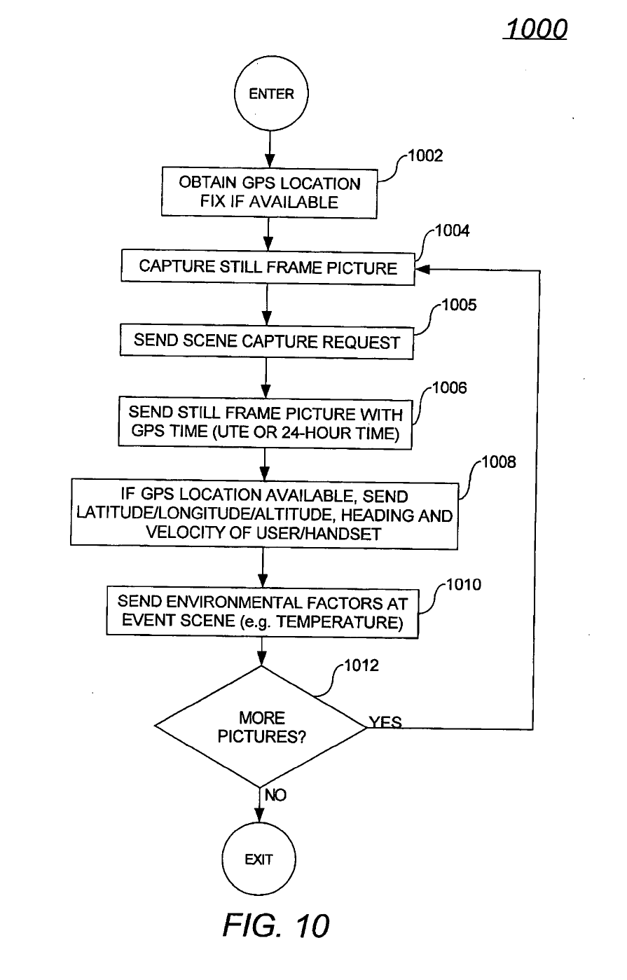

FIG. 10 illustrates an exemplary operational sequence for capturing and uploading still frame video from a handset device 102. Beginning at step 1002, the process obtains a GPS location fix on the handset device 102 if the handset device has this capability. Next, at step 1004, a still frame picture is captured in a manner well-known in the art. At step 1005, the handset 102 sends a scene capture request to the server 130 to notify the server that information is about to be transmitted. The still frame picture information is time-stamped and encoded with the time information from the instant the still frame is captured and the encoded image data is transmitted to the wide-area event information processing server 130, at step 1006. The time information is from the most accurate time available to the device 102, such as GPS or the system time. Next, if the GPS location information is available, the handset 102 transmits latitude, longitude, altitude, heading and velocity of the handset 102 to the event information processing server 130, at step 1008. Finally, any available relevant environmental factors from the event scene, such as temperature, are transmitted to the server 130, at step 1010. Finally, at step 1012, if the user wishes to send more pictures or there are more pictures previously queued and awaiting transmission, the process returns to step 1004 to process the next picture. Otherwise, the process ends.

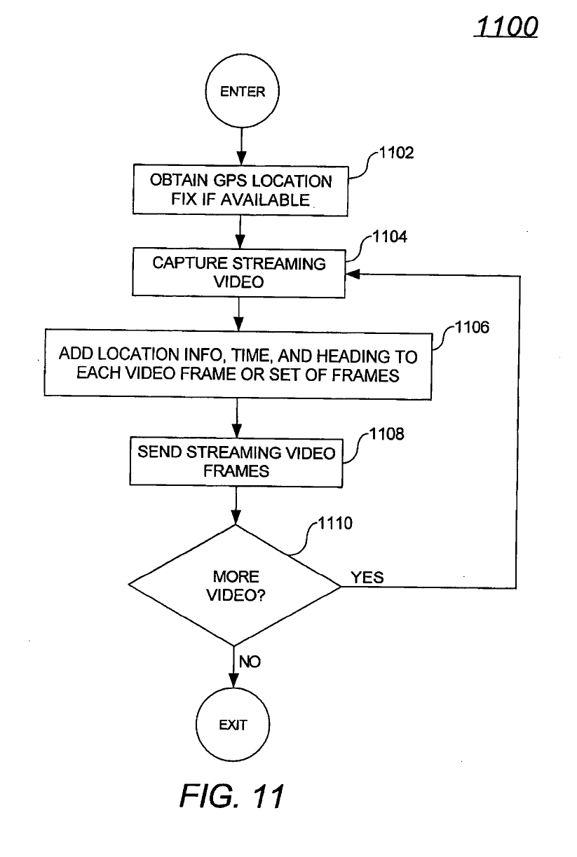

A similar operational sequence is followed in FIG. 11 to process streaming video. As with the method for capturing still frame images, the process begins, at step 1102, with the handset device 102 obtaining a GPS location fix if the device is so equipped. At step 1104, the device 102 begins capturing streaming video. Information such as location, time, and headings are added to each video frame or set of frames, in step 1106. At step 1108, a start scene capture request is transmitted to the server 130, followed by the video frames. Finally, at step 1110, the process checks to see if the user wishes to transfer more video and if so, returns to step 1104 to continue capturing.

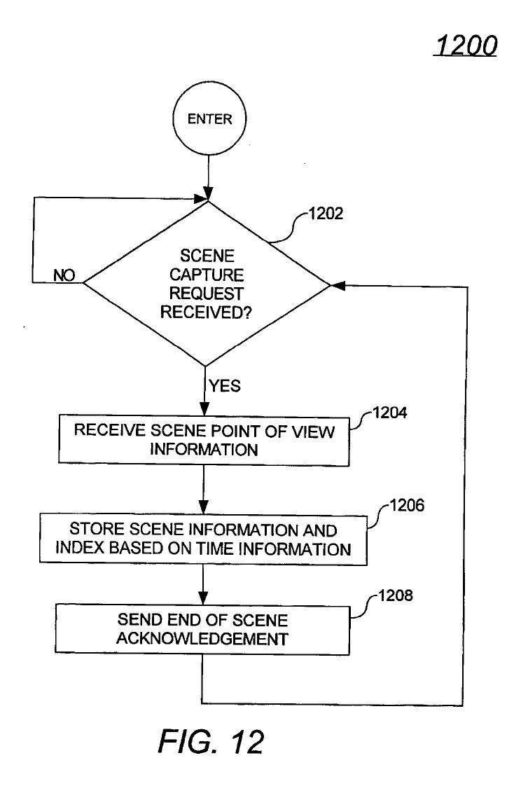

FIG. 12 illustrates the video capture/compile process from the point of the wide-area event information processing server 130. Beginning at step 1202, the server 130 receives a scene capture request from an input device such as a wireless handset 102. The server 130 next receives the video data and all relevant information concerning the point of view recorded from that particular input device 102, at step 1204. The server 130, stores the video data and its associated information and indexes this data based on the time information, at step 1206, then sends an end of scene acknowledgment, at step 1208, when the transmitted information has been received.

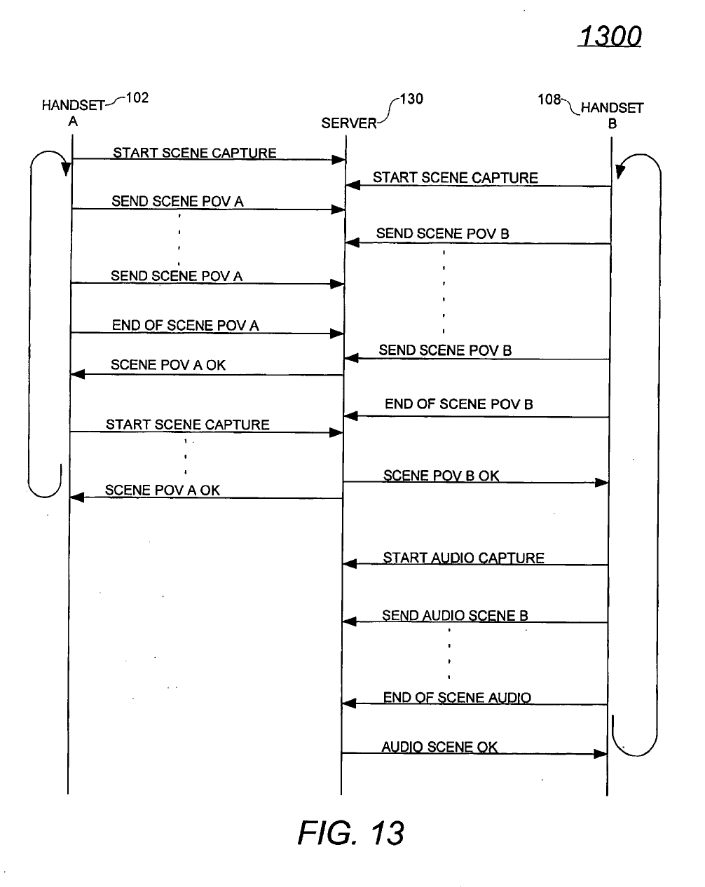

FIG. 13 is an information flow diagram illustrating the integrated process of uploading information to the server 130 from two exemplary input devices—handset A 102 and handset B 108. Scenes captured from the point of view of device A 102 (POV A) or device B 108 (POV B) can be either still frames or streaming video. As evidenced in FIG. 13, the server 130 may be contemporaneously receiving information from different sources containing a variety of information types. The input devices 102, 108 send a start scene capture request to the server 130 prior to uploading any information, upload the requested data, and then the server 130 sends an acknowledgement back to the handset device 102, 108 to verify the requested data was received before the handset 102, 108 is allowed to issue an additional start scene capture request.

Reconstruct/Playback Mode

The reconstruct/playback mode consists of the output portion of the system operation. Data collected, compiled, organized and stored in the capture/compile mode is delivered to various end-users, in a manner or format desired by the requesting user.

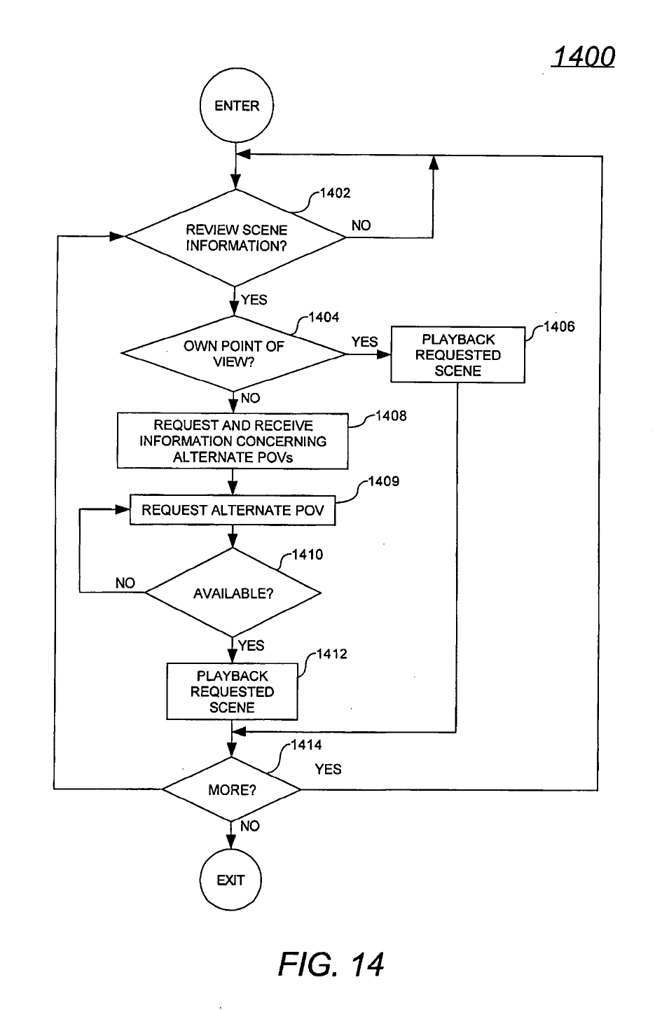

The user of a handset device 102 can request an audio, video, or combination audio/video playback of the event as recorded from his/her own point of view, or from another user's point of view, or a conglomeration of views and/or audio from a plurality of users. Additionally, if a particular view does not exist at the time of the playback request, the server later notifies that user that more information exists so that it may be requested for viewing. FIG. 14 depicts an exemplary operational sequence for a client output device, such as a wireless handset 102, requesting information for playback. Starting at step 1402, the user decides to review information taken at the scene of the wide-area event. If, at step 1404, the requested scene is that which was recorded from the requesting user's own vantage point, the requested scene is played back for the user, at step 1406. However, if the user wishes to review information collected from additional points of view, the handset is used to request and receive selection criteria for requesting these alternate points of view, at step 1408. The available alternate view points or audio recordings are presented at the handset device 102 in a number of forms. For instance, the server 103 can simply send the handset a listing of available records. Alternately, the server may send information representing geographical coordinate locations of the different available records and the coordinates may be superimposed over a map of the area to physically represent where the user recording the information was in relation to all other users at the time of the event. Additionally, such incidents as sporting events or music concerts, where users are assigned a specific seat in a certain section, an overlay of the stadium or concert venue itself can be displayed indicating a record is available from the vantage point of a certain seat within the stadium or concert hall. Next, an alternate point of view is requested at the handset device, at step 1409, and if the requested scene is available, at step 1410, the requested scene is received and played back to the user, at step 1412. If the user wishes to review additional information, at step 1414, the process returns to step 1402 to request a new scene for playback. For instance, it is possible that a user may want to view a scene received either just prior or just subsequent to receiving the scene he is presently viewing. He simply requests the next scene or previous scene and the time information for the next requested scene is adjusted accordingly. Otherwise, if the user does not wish to review more information, the process ends.

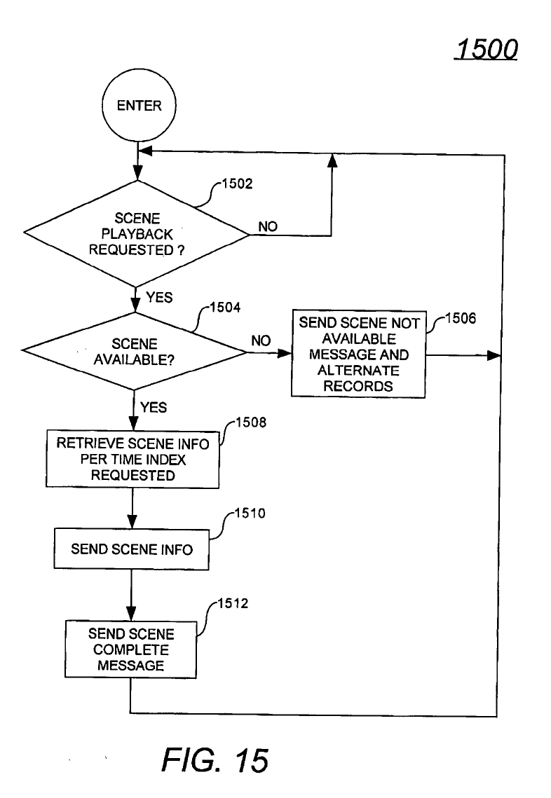

Operation from the wide-area event information processing server 130 is illustrated in FIG. 15, where the process begins, at step 1502, when a scene playback is requested. If the requested scene is available, at step 1504, the server 130 retrieves the requested scene information according to parameters set forth in the request, such as data source (user) or all records occurring within a specified time frame as indexed in event database 132, at step 1508, and the scene information is transmitted to the requesting handset device 102, at step 1510. When the all the requested scene information has been transmitted, the server 110 sends an acknowledgement to the handset device, at step 1512, indicating that the requested scene is complete. However, if the requested information is unavailable at step 1504, the server 130, at step 1506, sends a message to the handset device 102 informing the user that the requested information is unavailable as well as an indication of alternate available views, as discussed above.

It should be noted at this point that bandwidth restrictions may occur when a user would download from the server. In this instance, more information is requested than the user previously uploaded. There are known techniques for compressing audio, video and image files to allow for lossy and lossless types of compression.

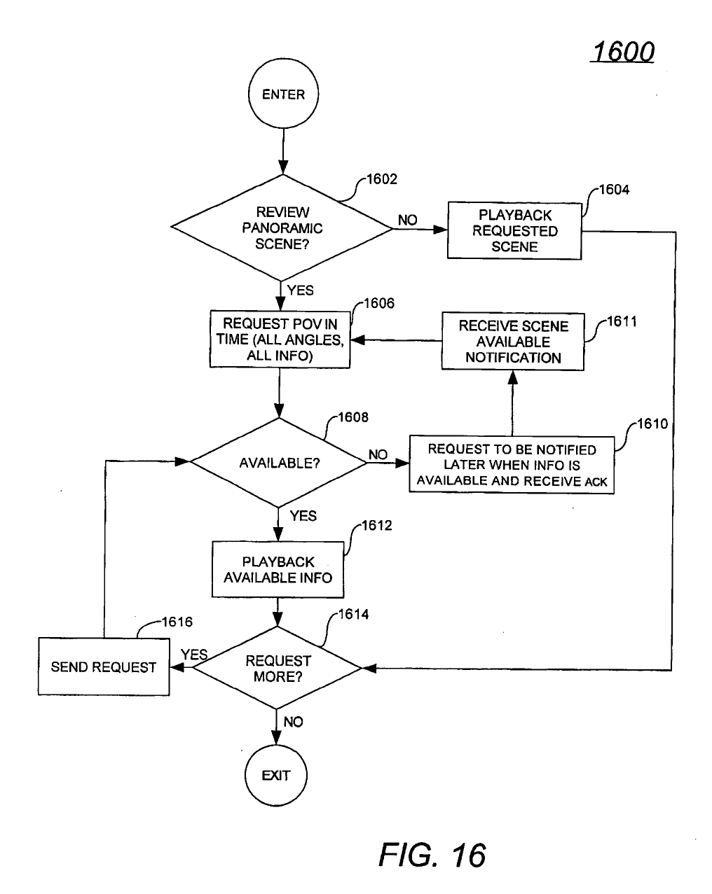

The system is also capable of creating and replaying combinations of information from a plurality of viewpoints. Such composite records or panoramic views are created at the request of the user and played back according to an exemplary operational sequence as detailed in FIG. 16. This process begins, at step 1602, when a user requests a playback of a recorded scene. If the requested scene is a single record, the selected scene is received at the handset device 102 and played back to the user, at step 1604. However, if the requested scene is a composite or panoramic view, the handset device must request the desired point of view according to parameters such as timeframe, desired data sources (angles), and type of data to be combined (e.g. two or more video images and one audio file). If the requested information is currently available, at step 1608, the server 130 merely transmits the requested file and the handset device presents this available information to the user, at step 1612. Because it would be an almost impossible, as well as impractical, task to have created every possible combination of data available at the server 130 and stored the records in the database 132 prior to receiving a request for the specified combination, a large portion of the actual creation of the files is performed upon the user's request. Therefore, at step 1608, when a particular panoramic view or requested combination of information is unavailable, the handset device 102 requests the server send a notification when the composite view is available and receives and acknowledgement from the server 130, at step 1610. Then, when the composite view is complete, the handset device 102 receives a scene available acknowledgement from the server 130, at step 1611, and again requests the desired composite view, at step 1606. After the requested scene is played back, at step 1612, if the user wishes to view additional playback of information, at step 1614, the new request is sent at step 1616; otherwise the process ends.

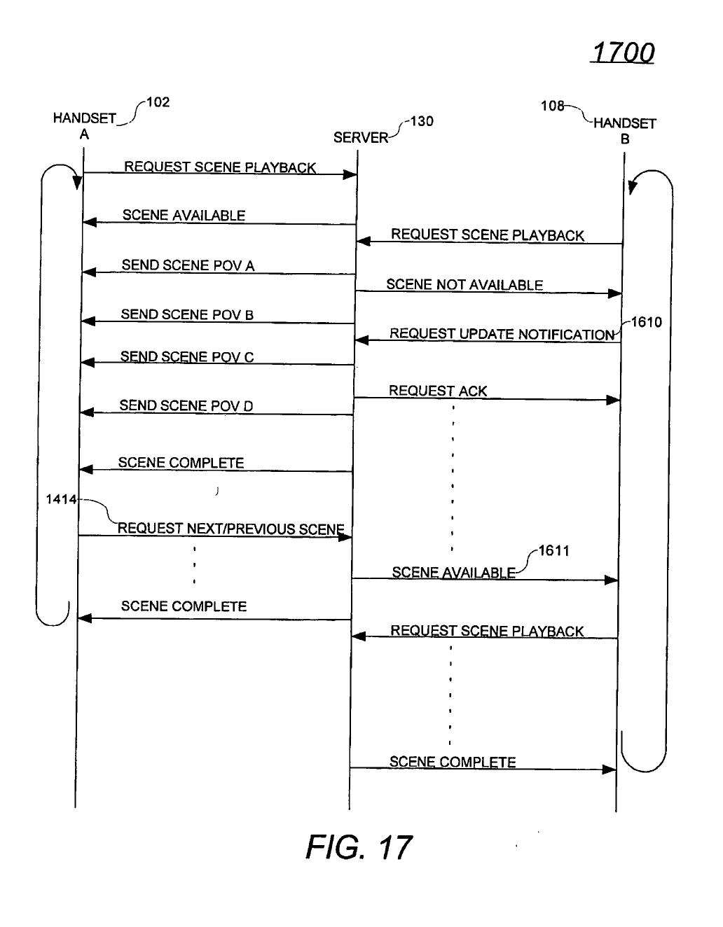

An information flow diagram of the output reconstruct/playback mode is illustrated in FIG. 17 where handset device A 102 is performing the sequence of operational steps shown in FIG. 14, server 130 is performing the sequence of steps shown in FIG. 15, and handset B 108 is performing the sequence of steps depicted in FIG. 16.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows a computer to read data, instructions, messages or message packets, and other computer readable information. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method for capturing event information relating to an event perceivable by at least one remote input device, the method comprising:
capturing event information, the event information comprising at least one of audio and video information, by at least one remote input device;
synchronizing the captured information to a time source;
encoding the synchronized information to a format suitable for transmission; and
transmitting the encoded information from the at least one remote input device, the transmitted, encoded information destined for reception by a central processing system.

2. The method of claim 1, wherein the captured event information is encoded with at least one of event-specific information, geographic location information, and ancillary information.

3. The method of claim 1, further comprising storing the encoded information at a memory location in the at least one remote input device.

4. The method of claim 1, wherein the at least one remote input device comprises a wireless device, and wherein the encoding of the synchronized information is to a format suitable for wireless transmission, and further wherein the transmitting comprises wirelessly transmitting encoded information from the at least one wireless device, destined for reception by a central processing system.

5. The method of claim 1, wherein the event perceivable to the at least one input device occurs external to the at least one input device.

6. The method of claim 1, wherein the event perceivable to the at least one input device occurs over a substantial geographic area.

7. A wireless input device for capturing event information relating to an event perceivable by the wireless input device, the device comprising:
means for capturing event information, the information comprising at least one of audio and video information;
means for synchronizing the captured information to a time source;
means for encoding the synchronized information to a format suitable for transmission; and
means for transmitting the encoded information from the at least one remote input device, the transmitted, encoded information destined for reception by a central processing system.

8. The wireless input device of claim 7, wherein the captured event information is encoded with at least one of event-specific information, geographic location information, and ancillary information.

9. The wireless input device of claim 7, further comprising means for storing the encoded information at a memory location in the at least one remote input device.

10. The wireless input device of claim 7, wherein the event perceivable to the at wireless input device occurs external to the at least one input device.

11. The wireless input device of claim 7, wherein the event perceivable to the at least one input device occurs over a substantial geographic area.

12. An event information processing system, comprising:
at least one remote input device for capturing event information perceivable by the at least one input device, the event information comprising at least one of audio and video event information; synchronizing the captured information to a time source, encoding the synchronized information to a format suitable for transmission; and transmitting the encoded information from the at least one remote input device, the transmitted, encoded information destined for reception by a central processing system; and
a central processing system, communicatively coupled to the at least one remote input device for receiving event information, the event information comprising at least one of captured audio and video event information from the at least one remote input device; decoding the received event information; storing the decoded event information in memory; compiling the stored, decoded event information according to a predefined arrangement; and analyzing the compiled event information.

13. The system of claim 12, wherein the event perceivable to the at least one remote input device occurs external to the at least one remote input device.

14. The system of claim 12, wherein the event perceivable to the at least one input device occurs over a substantial geographic area.

15. The system of claim 12, wherein the captured event information is encoded with at least one of event-specific information, geographic location information, and ancillary information.

16. The system of claim 12, wherein the at least one remote input device comprises a wireless device, and wherein the encoding of the synchronized information is to a format suitable for wireless transmission, and further wherein the transmitting comprises wirelessly transmitting encoded information from the at least one wireless device, destined for reception by a central processing system.

17. The system of claim 12, further comprising a plurality of remote input devices for capturing event information relating to an event perceivable by each remote input device, each remote input device capturing the event information from an independent vantage point.

18. The system of claim 17, wherein the event information captured from each remote input device is stored as an independent record.

19. The system of claim 18, wherein compiling the stored information comprises:
determining geographic location information for each independent stored record;
determining a relative location from the geographic location of each record received from a remote input device for a particular event to the geographic location of at least one other record received from a different remote input device of the plurality of remote input devices capturing event information of the same event from a different vantage point; and
creating a composite information file of the event using the geographic location of at least two independent stored records and the corresponding synchronized information.

20. The system of claim 17, wherein at least one remote input device of the plurality of remote input devices comprises a wireless device, and wherein the encoding of the synchronized information is to a format suitable for wireless transmission, and further wherein the transmitting comprises wirelessly transmitting encoded information from the at least one wireless device, destined for reception by a central processing system.
